(19) United States
(12) Patent Application Publication
(10) Pub. No.: US 2016/0055960 A1
(43) Pub. Date: Feb. 25, 2016

(54) POWER SUPPLY TRANSFORMER

(71) Applicant: FDK CORPORATION, Tokyo (JP)

(72) Inventors: Koji KANEKO, Tokyo (JP); Hideyuki AKIYAMA, Tokyo (JP); Takayuki SUZUKI, Tokyo (JP); Satoshi OTA, Tokyo (JP)

(21) Appl. No.: 14/779,578

(22) PCT Filed: Mar. 20, 2014
(86) PCT No.: PCT/JP2014/001642

§ 371 Date: Sep. 24, 2015

(30) Foreign Application Priority Data
Apr. 5, 2013 (JP) 2013-079108

(51) Int. Cl. H01F 27/28; H01F 27/02

(52) U.S. Cl. CPC H01F 27/2823; H01F 27/02

(57) ABSTRACT

A power supply transformer that can ensure a desired inter-coil creeping distance with no risk of insulation breakdown when high voltage is applied. The power supply transformer includes a case having a bottomed double tubular shape, a first coil accommodated between inner and outer tubes of the case, a lid body that closes an upper opening of the case, a second coil disposed on the upper surface of the lid body, and a core surrounding the case and the second coil. The first coil is formed only of a round wire wound in multiple layers. The lid body has a flat plate section on which the second coil is placed and a tubular inner wall section and outer wall section that cover the inner and outer circumferences of the second coil and stand on the flat plate section.

### TECHNICAL FIELD

The present invention relates to a power supply transformer preferably used with a power supply circuit in a variety of high-current-specification apparatuses.

### BACKGROUND ART

In general, in a transformer in which high current flows through a coil, a wire having a large cross-sectional area needs to be used to lower the resistance of the coil for suppression of heat generation.

As a wire having a large cross-sectional area, a configuration in which a flat electric wire is used and wound in an edgewise manner to form a coil has been proposed, as shown in Patent Literature 1 described below, but the configuration has a problem of an increase in manufacturing cost because the configuration itself is expensive.

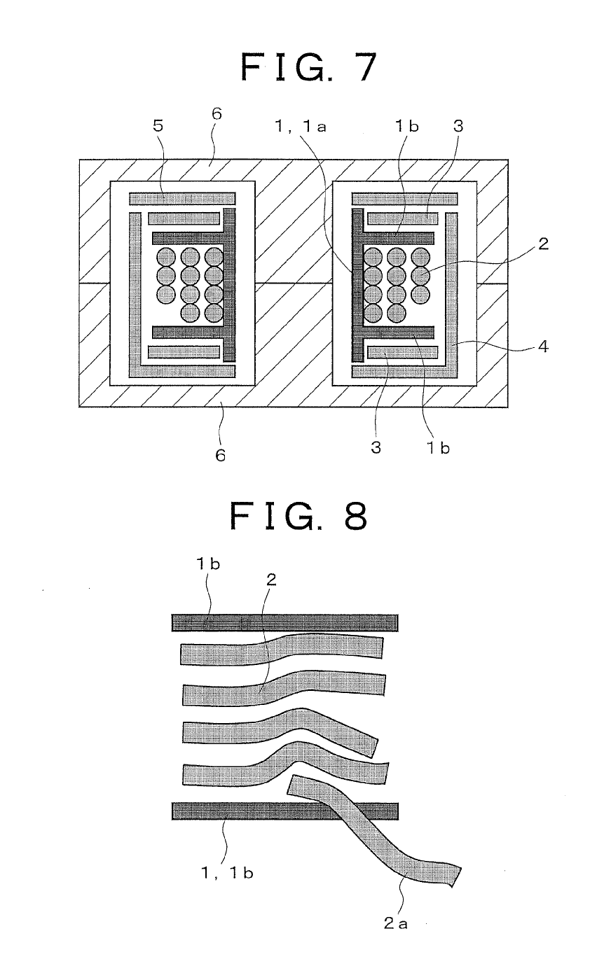

In view of the fact described above, a transformer formed of a coil using a large-diameter round wire combined with a coil produced in a stamping process in which a copper plate is stamped in an open ring shape, as shown in FIG. 7, has been widely used.

The transformer is a combination of a coil 2, which is formed of a thick round wire wound around a waist portion 1a of a bobbin 1, which is made of an insulating synthetic resin, in multiple layers (three layers in FIG. 7), and coils 3, which is each formed of a stamped copper plate and disposed in positions outside flanges 1b at opposite ends of the bobbin 1, with the coils 2 and 3 accommodated in an insulating case 4 having a bottomed tubular shape, and a pair of E-shaped cores 6 are so disposed that they face each other and surround the insulating case 4 and an insulating plate 5 placed on the coil 3 to form a closed magnetic circuit.

### CITATION LIST

### Patent Literature

Patent Literature 1: Japanese Patent Laid-Open No. 11-54345

### SUMMARY OF INVENTION

### Technical Problem

The transformer having the configuration described above undesirably has a difficulty in ensuring a desired creeping distance between the coil 2 and the copper plates 3. Further, the transformer has a large number of parts and hence has poor cost effectiveness, and particularly when the thick round wire is wound around the bobbin 1, the bobbin 1 tends to be cracked or distorted and it is difficult to smoothly form the coil 2 because the round wire is stiff and produces stress of a large magnitude, resulting in poor assembly workability.

Further, when the round wire is wound around the bobbin 2 in three or more layers with the wire turned in opposite directions, a drawn wire 2a, which is drawn through the bottom of the waist portion 1a of the bobbin 1, undesirably causes irregular winding in the coil 2, as shown in FIG. 8.

In addition, when high voltage is applied to the coil 2, insulation breakdown may possibly occur between the drawn wire 2a and the coil 2. That is, for example, when a voltage of 1000 V is applied to the coil 2 in which the wire is wound in four layers, the maximum voltage between adjacent layers is 500 V, but when the drawn wire 2a is in contact with the coil 2, the voltage of 1000 V is applied between the drawn wire 2a and the coil 2. Therefore, when the withstand voltage of an insulating coating of the round wire described above is 1000 V or lower, it is necessary to reliably prevent the drawn wire 2a from coming into contact with the coil 2.

The present invention has been made in view of the circumstances described above, and an object of the present invention is to provide a power supply transformer that can be easily assembled and is hence cost effective even when a coil is formed of a large-diameter round wire and can ensure a desired inter-coil creeping distance with no risk of insulation breakdown in a case where high voltage is applied.

### Solution to Problem

To achieve the object described above, an invention described in claim 1 relates to a power supply transformer characterized in that it comprises: a case produced by integral molding of an inner tube and an outer tube on a bottom plate by using an insulating material so that the case has a bottomed double tubular shape; a first coil accommodated between the inner tube and the outer tube of the case; a lid body that closes an upper opening of the case; a second coil disposed at least on an upper surface of the lid body; and a core that surrounds the case and the second coil to form a closed magnetic circuit, the first coil is formed only of a round wire wound in multiple layers, the lid body has a flat plate section on which the second coil is placed and tubular inner and outer wall sections extending along inner and outer circumferences of the second coil and standing on the flat plate section, and a guide that guides an end portion of the first coil that faces the bottom plate toward the outer tube is formed in the bottom plate of the case, and a cutout through which the end portion is drawn out of the case is formed in the outer tube.

An invention described in claim 2 is characterized in that in the invention described in claim 1, a locking section that prevents the end portion of the first coil that is drawn through the cutout from moving upward is formed on the outer tube.

An invention described in claim 3 is characterized in that in the invention described in claim 1 or 2, the second coil is formed of a flat electric wire, and the lid body is inserted through the upper opening of the case into a space between the outer tube and the inner tube.

An invention described in claim 4 is characterized in that in the invention described in any of claims 1 to 3, an engaging section is formed on each of the outer tube of the case and the lid body, and the engaging sections engage with each other when the upper opening is closed with the lid body to prevent the lid body from separating away from the case.

### Advantageous Effects of Invention

The invention described in any of claims 1 to 4 allows easy assembly and excellent cost effectiveness because a round wire is wound in advance around a fixture or any other component to form the shape of the first coil without use of a bobbin and the resultant first coil can be accommodated between the outer tube and the inner tube of the bottomed double tubular case followed by closure of the upper opening of the case with the lid body so that the first coil is disposed in the case.

Further, since the second coil is placed on the flat plate section of the lid body, and the outer wall section and the inner wall section, which each has a tubular shape and covers the outer and inner circumferences of the second coil, stand on the flat plate section, a creeping distance corresponding at least to the height dimension of the inner and outer wall section is provided between the first coil and the second coil. Setting the height dimension at an appropriate value therefore allows a desired creeping distance to be reliably ensured between the first coil and the second coil.

Further, since the end portion of the first coil, which is accommodated in the case, specifically, the end portion that faces the bottom plate of the case, is drawn out of the case through the guide formed in the bottom plate and further through the cutout formed in the outer tube, contact of the drawn end portion of the coil with the coil can be prevented, whereby there is no risk of insulation breakdown even when high voltage is applied.

In particular, in the invention described in claim 2, since a locking section that prevents the end portion of the first coil that is drawn out through the cutout from moving upward is formed on the outer tube, contact of the drawn end portion with the coil can be reliably prevented even if external force toward the outer circumference of the coil acts on the drawn end portion.

Further, according to the invention described in claim 3, since the lid body is inserted through the upper opening of the case into the space between the outer tube and the inner tube, the overall dimension of the coil in the radial direction can be reduced as compared with a case where the outer wall section of the lid body is so attached to the case that the lid body covers the outer circumference of the outer tube of the case, and use of a flat electric wire as the second coil allows the overall dimension of the coil in the axial direction to be reduced, whereby the size of the entire power supply transformer can be reduced.

Further, according to the invention described in claim 4, the engaging sections that engage with each other when the upper opening of the case is closed with the lid body to prevent the lid body from separating away from the case are formed. Therefore, even when vibration or any other external action moves the first coil accommodated in the case in the axial direction, the engaging sections reliably prevent the lid body from separating away from the case, whereby the reliability of the power supply transformer can be improved.

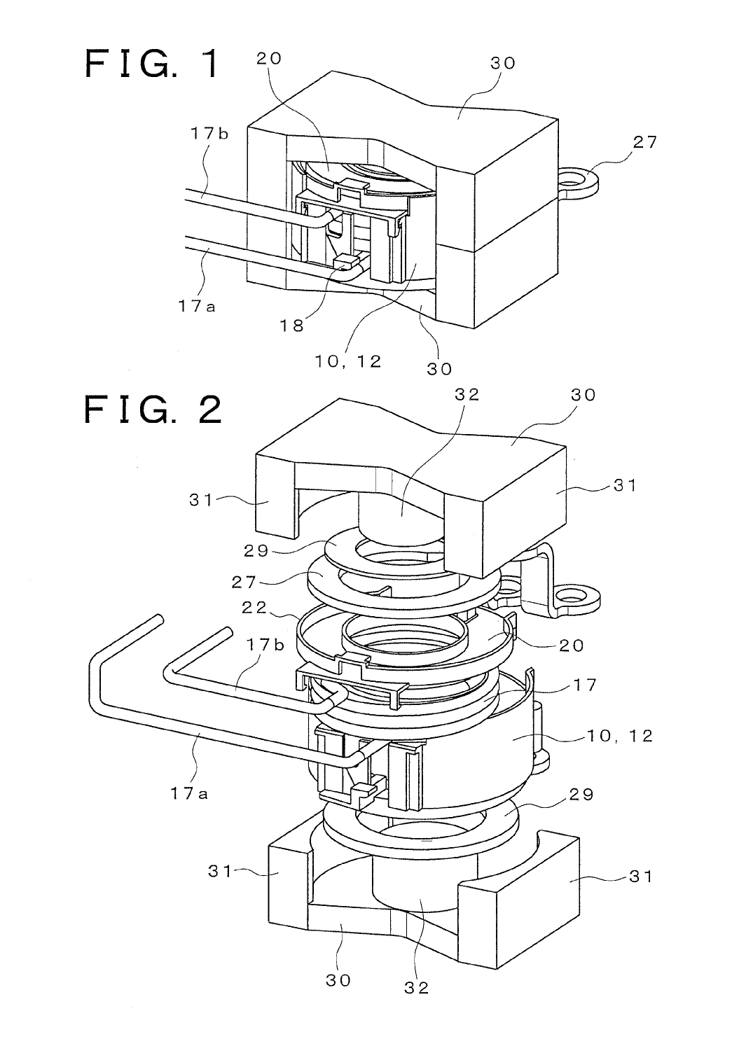

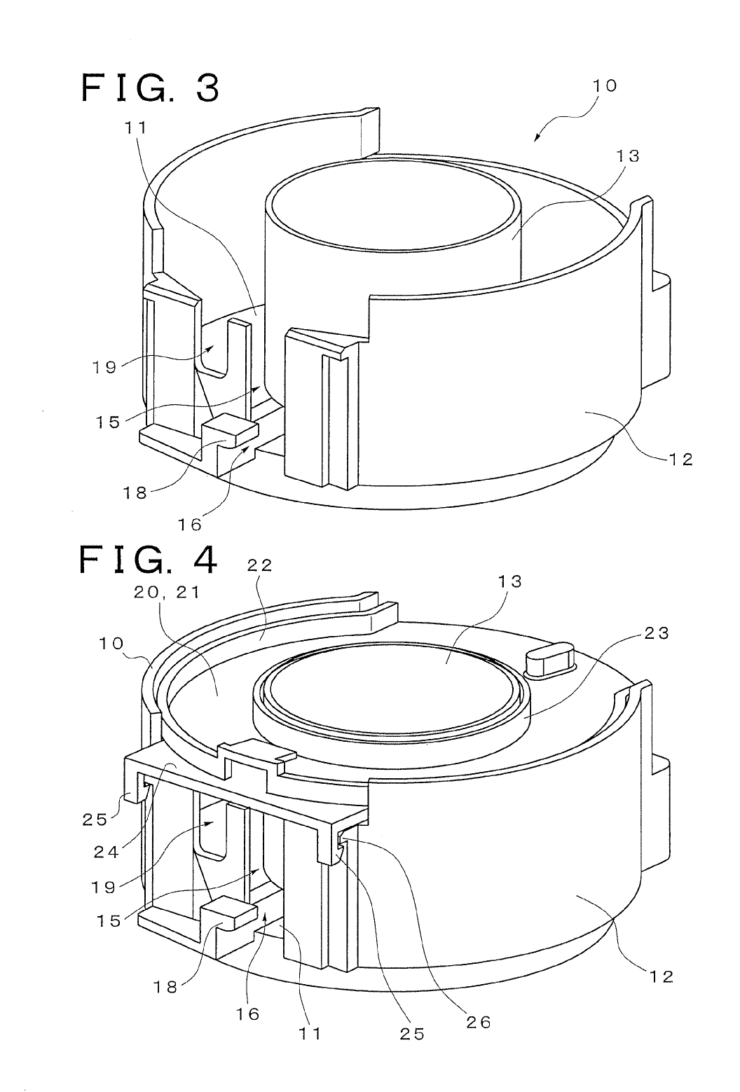

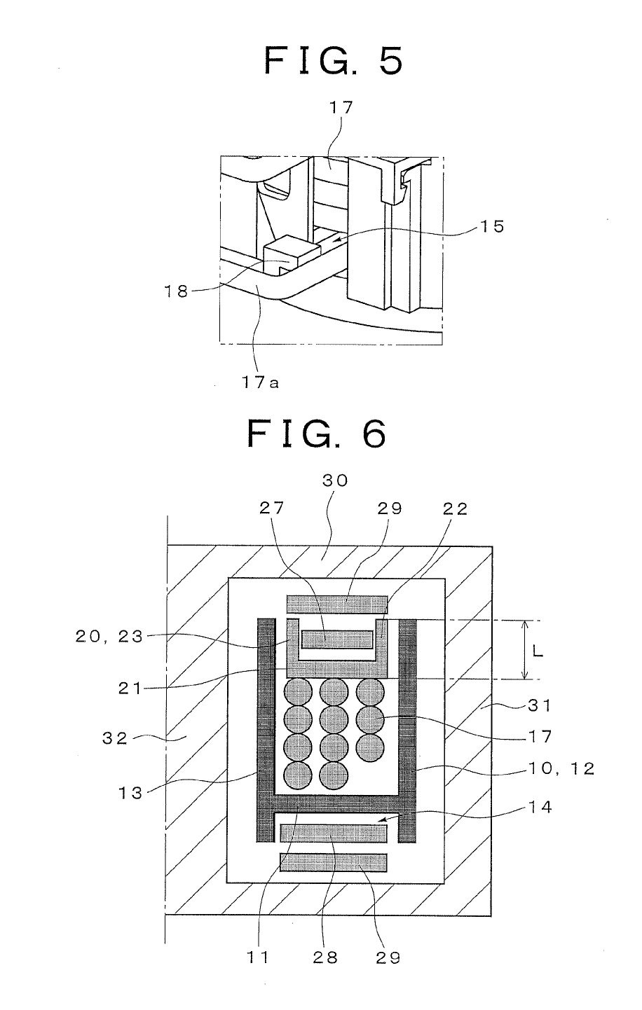

### BRIEF DESCRIPTION OF DRAWINGS

[FIG. 1] FIG. 1 is a perspective view showing an embodiment of a power supply transformer according to the present invention.

[FIG. 2] FIG. 2 is an exploded perspective view of FIG. 1.

[FIG. 3] FIG. 3 is a perspective view showing a case in FIG. 2.

[FIG. 4] FIG. 4 is a perspective view showing a state in which a lid body is attached to the case in FIG. 3.

[FIG. 5] FIG. 5 is an enlarged view of a bottom portion of the case in FIG. 1.

[FIG. 6] FIG. 6 is a diagrammatic longitudinal cross-sectional view of FIG. 1.

[FIG. 7] FIG. 7 is a diagrammatic longitudinal cross-sectional view showing a power supply transformer of related prior art.

[FIG. 8] FIG. 8 is a side view showing a coil in FIG. 7 and a portion drawn therefrom.

### DESCRIPTION OF EMBODIMENTS

FIGS. 1 to 6 show an embodiment of a power supply transformer according to the present invention, and reference character 10 in FIGS. 1 to 6 denotes a case.

The case 10 includes a disk-shaped bottom plate 11, an outer tube 12, which is so provided that it stands on the outer periphery of the bottom plate 11, and an inner tube 13, which is so provided that it stands on a portion around a hole formed in a central portion of the bottom plate 11, with the bottom plate 11, the outer tube 12, and the inner tube 13 molded integrally with each other in a bottomed double tubular shape by using an insulating synthetic resin.

The outer tube 12 and the inner tube 13 of the case 10 are so formed that they protrude downward from the bottom plate 11, and a recess 14 (see FIG. 6) is therefore formed on the rear side of the bottom plate 11. A cutout 15 is formed in the outer tube 11 and extends from an upper opening thereof to the bottom plate 11, and a groove (guide) 16, which opens through the cutout 15, is formed in the bottom plate 11. A first coil 17 is accommodated between the outer tube 12 and the inner tube 13 of the case 10.

The first coil 17 is so formed that a large-diameter round wire is wound in advance in multiple layers with turns (three layers in FIGS. 1 to 6) around a fixture having a columnar or hollow cylindrical shape, and opposite end portions 17a and 17b of the first coil 17 form drawn wires. The first coil 17 is then inserted into the case 10 with the end portion 17a, which faces the bottom plate 11 of the case 10, inserted through the cutout 15.

Further, the end portion 17a described above is inserted into and guided by the groove 16, which is formed in the bottom plate 11, and drawn outward through the bottom of the cutout 15.

Further, a locking section 18, which protrudes to a point above the end portion 17a drawn through the cutout 15 and cooperates with the cutout 15 to prevent the drawn end portion 17a from moving, is formed on the outer surface of the outer tube 12 integrally therewith.

In the present embodiment, a cutout 19, which extends from the upper opening in the axial direction in parallel to the cutout 15, is further formed in the outer tube 12, and the other end portion 17b of the first coil 17 is inserted through the cutout 19. A space is therefore formed between the upper opening of the case 10 and the upper end of the first coil 17. In the space is placed a lid body 20, which closes the upper opening of the case 10.

The lid body 20 is formed of a flat plate section 21, which has a circular ring plate shape with a circular opening formed in a central portion thereof, an outer wall section 22, which is so provided that it stands on the outer periphery of the flat plate section 21, and an inner wall section 23, which is so provided that it stands on the inner periphery of the flat plate section 21. The lid body 20 is so formed that the outer diameter of the outer wall section 22 is slightly smaller than the inner diameter of the outer tube 12 of the case 10 and the inner diameter of the inner wall section 23 is slightly greater than the outer diameter of the inner tube 13 of the case 10. The thus configured lid body 20 is inserted into the space described above, which is located above the first coil 17, which is formed between the outer tube 12 and the inner tube 13 of the case 10.

Further, a flange 24, which protrudes outward from the outer tube 12 of the case 10, is formed on the outer surface of the outer wall section 22 of the lid body 20, and engaging sections 25, each of which extends downward in an L-like shape, are formed at opposite ends of the lower surface of the front end of the flange 24. On the other hand, engaging sections 26, which each has an inverted L-like shape and engage with the engaging sections 25 of the lid body 20 to prevent the lid body 20 from moving upward when the lid body 20 is inserted into the space between the outer tube 12 and the inner tube 13 of the case 10, are formed in portions of the outer surface of the outer tube 12 of the case 10 that face the engaging sections 25.

A second coil 27 is then placed on the flat plate section 21 of the lid body 20, specifically, in a recess thereof formed by the outer wall section 22 and the inner wall section 23, and a second coil 28 is accommodated in the recess 14, which is formed on the rear side of the bottom plate 11 of the case 10. Each of the second coils 27 and 28 is formed of a flat copper wire (flat electric wire) produced in a stamping process in which a copper plate is stamped in an open ring shape.

Insulating plates 29, each of which has a circular ring plate shape, are then disposed on the upper surface of the second coil 27 and the lower surface of the second coil 28, and a pair of E-shaped cores 30, which form a closed magnetic circuit along the outer circumferences of the insulating plates 29, are so disposed that they face each other in an opposed, confronting relation. Each of the E-shaped cores 30 has outer legs 31 each having an arcuate inner surface and a middle leg 32 having a columnar cylindrical shape with the outer legs 31 disposed along the outer tube 12 of the case 10 and the middle leg 32 inserted into the inner tube 13 of the case 10 so that the middle leg 32 and the inner tube 13 face each other in an opposed, confronting relation.

The thus configured power supply transformer can be easily assembled and excels in cost effectiveness because a thick round wire is wound in advance around a fixture or any other component to form the shape of the first coil 17 and the resultant first coil 17 can be accommodated between the outer tube 12 and the inner tube 13 of the case 10 followed by closure of the upper opening of the case with the lid body 20 so that the first coil 17 is disposed in the case 10.

Further, since the second coil 27 is placed on the flat plate section 21 of the lid body 20, and the outer wall section 22 and the inner wall section 23, which each has a tubular shape and covers the outer and inner circumferences of the second coil 27, stand on the flat plate section 21, a creeping distance corresponding at least to a height dimension L of the outer wall section 22 and the inner wall section 23 is provided between the first coil 17 and the second coil 27, as shown in FIG. 6. Setting the height dimension L at an appropriate value therefore allows a desired creeping distance to be reliably ensured between the first coil 17 and the second coil 27.

Moreover, the end portion 17a, which is an end portion of the first coil 17, which is accommodated in the case 10, and faces the bottom plate 11 of the case 10, is drawn out of the case 10 through the groove 16 formed in the bottom plate 11 and further through the cutout 15 formed in the outer tube 12, and the locking section 18 prevents the end portion 17a from moving upward, contact of the drawn end portion 17a of the coil 17 with the coil 17 can be reliably prevented. As a result, there is no risk of insulation breakdown even when high voltage is applied.

In addition, the engaging sections 25 and 26, which engage with each other when the lid body 20 is inserted through the upper opening of the case 10 to prevent the lid body 20 from separating away from the case 10, are formed. Therefore, even when vibration or any other external action moves the first coil 17 accommodated in the case 10 in the axial direction, the engaging sections 25 and 26 reliably prevent the lid body 20 from separating away from the case 10, whereby the reliability of the power supply transformer can be improved.

### INDUSTRIAL APPLICABILITY

The present invention can provide a power supply transformer that can be easily assembled and is hence cost effective and can ensure a desired inter-coil creeping distance with no risk of insulation breakdown in a case where high voltage is applied.

### REFERENCE SIGNS LIST

10 Case
11 Bottom plate
12 Outer tube
13 Inner tube
14 Cutout
15 Groove (guide)
16 First coil
17a, 17b End portion
18 Locking section
20 Lid body
21 Flat plate section
22 Outer wall section
23 Inner wall section
25, 26 Engaging section
27, 28 Second coil
30 E-shaped core

1. A power supply transformer comprising:
a case produced by integral molding of an inner tube and an outer tube on a bottom plate by using an insulating material so that the case has a bottomed double tubular shape;
a first coil accommodated between the inner tube and the outer tube of the case;
a lid body that closes an upper opening of the case;
a second coil disposed at least on an upper surface of the lid body; and
a core that surrounds the case and the second coil to form a closed magnetic circuit,
the first coil is formed only of a round wire wound in multiple layers,
the lid body has a flat plate section on which the second coil is placed and tubular inner and outer wall sections extending along inner and outer circumferences of the second coil and standing on the flat plate section, and
a guide that guides an end portion of the first coil that faces the bottom plate toward the outer tube is formed in the bottom plate of the case, and a cutout through which the end portion is drawn out of the case is formed in the outer tube.

2. The power supply transformer according to claim 1,
wherein a locking section that prevents the end portion of the first coil that is drawn through the cutout from moving upward is formed on the outer tube.

3. The power supply transformer according to claim 1,
wherein the second coil is formed of a flat electric wire, and the lid body is inserted through the upper opening of the case into a space between the outer tube and the inner tube.

4. The power supply transformer according to claim 1,
wherein an engaging section is formed on each of the outer tube of the case and the lid body, and the engaging sections engage with each other when the upper opening is closed with the lid body to prevent the lid body from separating away from the case.
